(19) United States
(12) Patent Application Publication
(10) Pub. No.: US 2025/0008589 A1
(43) Pub. Date: Jan. 2, 2025

(54) SYSTEMS AND METHODS FOR OPERATING TERRESTRIAL NETWORK AND NON-TERRESTRIAL NETWORK ON THE SAME SPECTRUM

(71) Applicant: Verizon Patent and Licensing Inc., Basking Ridge, NJ (US)

(72) Inventors: Lei Song, Basking Ridge, NJ (US); Lily Zhu, Parsippany, NJ (US); Jin Yang, Orinda, CA (US); Zheng Zhao, Plainsboro, NJ (US); Edward Diaz, Bridgewater, NJ (US)

(21) Appl. No.: 18/344,348

(22) Filed: Jun. 29, 2023

(51) Int. Cl. H04W 76/18; H04W 8/00

(52) U.S. Cl. CPC H04W 76/18; H04W 8/005; H04W 84/06

(57) ABSTRACT

A user equipment (UE) device may include a processor configured to attempt to connect to a wireless network; detect a base station signal from a terrestrial network (TN) base station; and determine that a connection attempt to the TN base station was not successful. The processor may be further configured to designate the UE device as an interfering UE device, based on detecting the base station signal from the TN base station and determining that the connection attempt to the TN base station was not successful and connect to a non-terrestrial (NTN) base station using a sub-band mode, in response to designating the UE device as an interfering UE device.

### BACKGROUND INFORMATION

To satisfy the needs and demands of users of mobile communication devices, providers of wireless communication services continue to improve and expand their networks. One aspect of such improvements includes the development of wireless access networks and options to utilize such wireless access networks. A provider may operate a terrestrial wireless network and a non-terrestrial wireless network that provides coverage for areas with poor coverage by the terrestrial network. Managing terrestrial and non-terrestrial wireless networks poses various challenges.

### BRIEF DESCRIPTION OF THE DRAWINGS

FIG. 1 illustrates an environment according to an implementation described herein;

FIG. 2 illustrates exemplary components of a device that may be included in a component of an environment according to an implementation described herein;

FIG. 3 illustrates exemplary components of a user equipment (UE) device according to an implementation described herein;

FIG. 4 illustrates exemplary components of an interference management database according to an implementation described herein;

FIG. 5 illustrates exemplary components of a base station device according to an implementation described herein;

FIGS. 6A and 6B illustrate a flowchart for selecting a communication mode according to an implementation described herein;

FIG. 7 illustrates a flowchart for establishing a sub-band mode according to an implementation described herein;

FIG. 8 illustrates an exemplary system that includes a terrestrial and non-terrestrial network according to an implementation described herein;

FIG. 9 illustrates an exemplary signal flow according to an implementation described herein; and

FIG. 10 illustrates an exemplary band with sub-bands according to an implementation described herein.

### DETAILED DESCRIPTION OF EMBODIMENTS

The following detailed description refers to the accompanying drawings. The same reference numbers in different drawings identify the same or similar elements.

A cellular wireless network enables user equipment (UE) devices to connect to networks via a Radio Access Network (RAN) and a core network in order to communicate with other devices connected to the RAN, communicate with devices in other networks, access applications or services hosted by a provider in the core network, and/or make use of other types of communication services. As cellular wireless networks and services increase in size, complexity, and number of users, management of the communication networks has become more complex. One way in which wireless networks are becoming more complicated is by incorporating various aspects of next generation networks, such as 5th generation (5G) mobile networks, utilizing high frequency bands (e.g., 24 Gigahertz, 39 GHz, etc.), and/or lower frequency bands such as Sub 6 GHz, and a large number of antennas. 5G New Radio (NR) radio access technology (RAT) provides significant improvements in bandwidth and/or latency over other wireless network technology. Additionally, a 5G core network supports and manages 5G RANs that include base stations, providing various services and enabling connections to other networks (e.g., connections to the Internet, etc.). As an example, a 5G core network may provide support for enhanced Mobile Broadband (eMBB), ultra-reliable low latency communication (URLLC), massive Machine Type Communication (mMTC), and/or other types of communications.

Another enhancement to cellular wireless communication services is the deployment of non-terrestrial networks (NTNs). While a terrestrial network (TN) includes terrestrial base stations, an NTN may include one or more satellites configured to communicate with UE devices using cellular wireless signals. An NTN satellite may function as a base station (e.g., a 5G base station) and/or as a repeater between UE devices and a terrestrial base station. NTN satellites may provide coverage in areas with poor coverage by TN base stations.

A challenge in deploying and managing NTNs is that a frequency band used by an NTN may overlap with a frequency band used by a TN. For example, the Third Generation Partnership Project (3GPP) NTN Kₐ band may overlap with a 5G millimeter (mm) wave band. An NTN Kₐ band may be defined as a single fully harmonized earth-to-space band in the 27.5-30.0 GHz range with specific network signaling to address region-specific requirements and restrictions, and/or additional bands in the 27.5-28.35 GHz range and in the 28.35-30.0 GHz range for the United States and subject to regulations by the Federal Communications Commission (FCC). Such an NTN Kₐ band may interfere with 5G NR TN bands, such as, for example, the 26.5-29.5 GHz n257 band and/or the 27.5-28.35 GHz n261 band. In particular, a transmission from an NTN UE device to a satellite may interfere with the uplink reception of a TN base station and/or with the downlink reception of a TN UE device. Thus, NTN UE devices may cause interference to a TN operating on the same spectrum.

Implementations described herein relate to systems and methods for operating a TN and an NTN on the same spectrum. A UE device may be configured to determine whether connecting to an NTN base station would cause the UE device to interfere with a TN base station and/or UE device. If the UE device determines that connecting to the NTN base station would result in interference with a TN, the UE device may select to connect to the NTN base station using a sub-band mode. In a sub-band mode, a band may be split into two or more sub-bands and an NTN may use a first sub-band and a TN may use a second sub-band in the area where the interference is determined to occur. The NTN base station and the TN base station may coordinate to switch from operating on a full band to operating on their respective sub-bands.

For example, a UE device may attempt to connect to a wireless network and perform a cell search to detect primary synchronization signals transmitted by TN base stations. If a TN base station is detected, the UE device may attempt to connect to the TN base station. If the connection attempt is successful, the UE device may communicate using the TN base station and terminate attempts to connect to the NTN base station. Thus, in such a situation, interference between the TN and an NTN as a result of the UE device may not be an issue.

If the connection attempt is not successful, the UE device may designate itself as an interfering UE device, based on detecting the TN base station signal and determining that the connection attempt to the TN base station was not successful, and connect to an NTN base station using a sub-band mode. The UE device may send a connection request to a satellite associated with the NTN base station along with a request to operate in sub-band mode and information identifying the detected TN base station.

The NTN base station may then coordinate with the identified TN base station to select sub-band parameters for operating in sub-bands of a band shared by the NTN and TN. The sub-band parameters may include, for example, frequency ranges and/or channels for each sub-band, antenna beams associated with each sub-band, time slots for uplink and/or downlink transmissions on each sub-band, and/or other types of sub-band parameters. The UE device may then connect to the NTN base station via the satellite using the selected sub-band parameters. For example, the UE device may apply a sub-band filter to signals sent to the NTN and/or to signals received from the NTN.

If the UE device does not detect a TN base station, the UE device may determine whether cross-link interference (CLI) exists with respect to another UE device. The UE device may detect CLI by, for example, detecting a Sounding Reference Signal (SRS) from another UE device. If the UE detects CLI with respect to another UE device, the UE device may designate itself as an interfering UE device, based on detecting the CLI, and select to connect to the NTN base station using a sub-band mode. If the UE does not detect CLI with respect to another UE device, the UE device may designate itself as a non-interfering UE device, based on detecting no CLI, and select to connect to the NTN base station using a full-band mode. Thus, the UE device may use the full band to communicate with the NTN base station via the satellite.

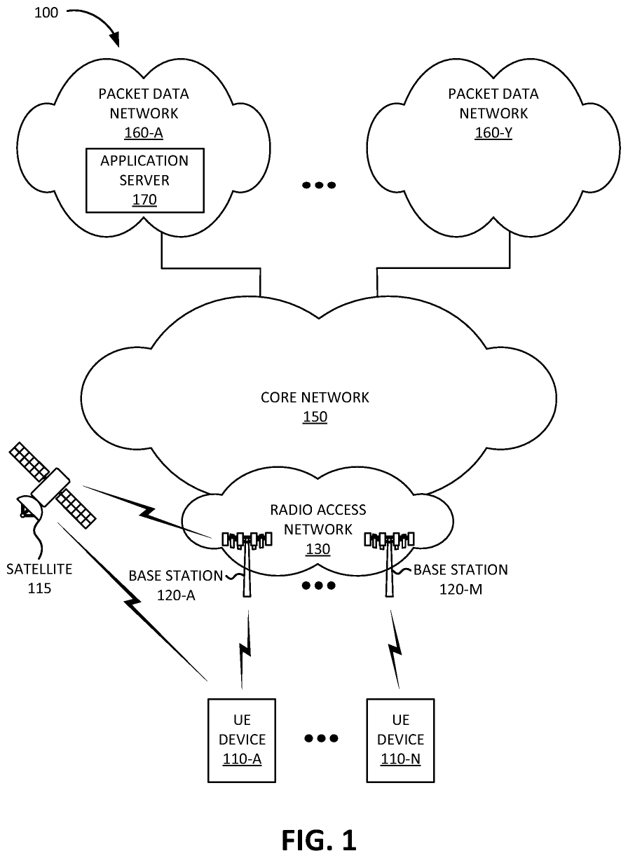

FIG. 1 is a diagram of an exemplary environment 100 in which the systems and/or methods described herein may be implemented. As shown in FIG. 1, environment 100 may include UE devices 110-A to 110-N (referred to herein collectively as “UE devices 110” and individually as “UE device 110”), a satellite 115 and base stations 120-A to 120-M (referred to herein collectively as “base stations 120” and individually as “base station 120”) in RAN 130, core network 150, and packet data networks (PDNs) 160-A to 160-Y (referred to herein collectively as “PDNs 160” and individually as “PDN 160”)

UE device 110 may include any device with cellular wireless communication functionality. For example, UE device 110 may include a handheld wireless communication device (e.g., a mobile phone, a smart phone, a tablet device, etc.); a wearable computer device (e.g., a head-mounted display computer device, a head-mounted camera device, a wristwatch computer device, etc.); a laptop computer, a tablet computer, or another type of portable computer; a desktop computer; a customer premises equipment (CPE) device, such as a set-top box or a digital media player (e.g., Apple TV, Google Chromecast, Amazon Fire TV, etc.), a Wi-Fi® access point, a fixed wireless access device, a smart television, etc.; a portable gaming system; a global positioning system (GPS) device; a home appliance device; a home monitoring device; and/or any other type of computer device with wireless communication capabilities. In some implementations, UE device 110 may communicate using machine-to-machine (M2M) communication, such as Machine Type Communication (MTC), and/or another type of M2M communication for IoT applications. UE device 110 may be enabled for communicating with a TN via base station 120 and for communicating with an NTN via satellite 115. For example, UE device may include a first radio frequency (RF) transceiver, communication interface, modem, and/or chipset for communicating with base station 120 and a second RF transceiver, communication interface, modem, and/or chipset for communicating with satellite 115.

RAN 130 may include base stations 120 and satellite 115. Satellite 115 may include a wireless transceiver configured to communicate using a specific frequency band such as a Kₐ band, for example. In some implementations, satellite 115 may function as a repeater, for a particular base station 120, that retransmits signals from the particular base station 120 to UE devices 110 registered with the particular base station 120 and/or retransmit signals from UE devices 110 registered with the particular base station 120 to the particular base station 120. In other implementations, satellite 115 may include the functionality of base station 120. Satellite 115 may include a low Earth orbit (LEO) satellite, a geosynchronous satellite, a medium Earth orbit (MEO) satellite, and/or another type of satellite. While a single satellite 115 is shown in FIG. 1 for illustrative purposes, in practice, RAN 130 may include multiple satellites 115. Satellites 115 and base stations 120 of RAN 130 for which satellites 115 function as repeaters correspond to an NTN. Other base stations 120 of RAN 130 that do not use satellites 115 as repeaters correspond to a TN. Satellite 115 may be controlled and/or managed by a separate provider of communication services that may be the same as, or different than, the provider associated with a TN.

Base station 120 may be configured for one or more RAT types. For example, base station 120 may include a 5G New Radio (NR) base station (e.g., a gNodeB) and/or a Fourth Generation (4G) Long Term Evolution (LTE) base station (e.g., an eNodeB). Each base station 120 may include devices and/or components that enable cellular wireless communication with UE devices 110. For example, base station 120 may include an RF transceiver configured to communicate with UE devices 110 using a 5G NR air interface, a 4G LTE air interface, and/or using another type of cellular air interface. Base station 120 may enable UE device 110 to communicate with core network 150.

Core network 150 may be managed by a provider of cellular wireless communication services and may manage communication sessions of subscribers connecting to core network 150 via RAN 130. For example, core network 150 may establish an Internet Protocol (IP) connection between UE devices 110 and PDN 160. In some implementations, core network 150 may include a 5G core network. In other implementations, core network 150 may include a 4G core network (e.g., an evolved packet core (EPC) network) and/or another type of core network.

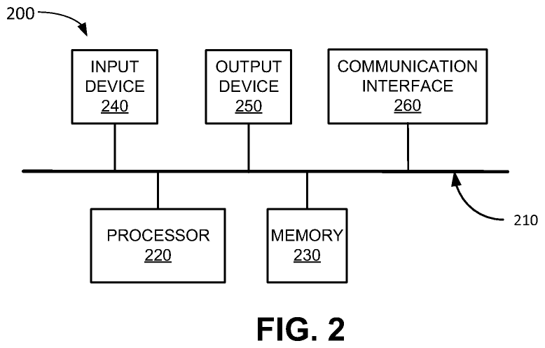

The components of core network 150 may be implemented as dedicated hardware components or as virtualized functions implemented on top of a common shared physical infrastructure using Software Defined Networking (SDN). For example, an SDN controller may implement one or more of the components of core network 150 using an adapter implementing a virtual network function (VNF) virtual machine, a Cloud Native Function (CNF) container, an event driven serverless architecture interface, and/or another type of SDN component. The common shared physical infrastructure may be implemented using one or more devices 200 described below with reference to FIG. 2 in a cloud computing center associated with core network 150.

PDNs 160-A to 160-Y may each include a PDN. A particular PDN 160 may be associated with a Data Network Name (DNN) in 5G, and/or an Access Point Name (APN) in 4G. A UE device may request a connection to PDN 160 using a DNN or an APN. PDN 160 may include, and/or be connected to, a local area network (LAN), a wide area network (WAN), a metropolitan area network (MAN), an autonomous system (AS) on the Internet, an optical network, a cable television network, a satellite network, a wireless network (e.g., a CDMA network, a general packet radio service (GPRS) network, and/or an LTE network), an ad hoc network, a telephone network (e.g., the Public Switched Telephone Network (PSTN) or a cellular network), an intranet, or a combination of networks.

PDN 160 may include an application server 170 (shown in PDN 160-A in FIG. 1 for illustrative purposes). Application server 170 may provide services for an application running on UE device 110 and may establish an application session with UE device 10 via RAN 130 and core network 150. RAN 130 and core network 150 may establish a communication session or data flow between UE device 110 and application server 170.

Although FIG. 1 shows exemplary components of environment 100, in other implementations, environment 100 may include fewer components, different components, differently arranged components, or additional components than depicted in FIG. 1. Additionally, or alternatively, one or more components of environment 100 may perform functions described as being performed by one or more other components of environment 100.

FIG. 2 illustrates example components of a device 200 according to an implementation described herein. UE device 110, satellite 115, base station 120, application server 170, and/or other components of core network 150 or RAN 130, may each include one or more devices 200. As shown in FIG. 2, device 200 may include a bus 210, a processor 220, a memory 230, an input device 240, an output device 250, and a communication interface 260.

Bus 210 may include a path that permits communication among the components of device 200. Processor 220 may include any type of single-core processor, multi-core processor, microprocessor, latch-based processor, central processing unit (CPU), and/or processing logic (or families of processors, microprocessors, and/or processing logics) that interprets and executes instructions. In other embodiments, processor 220 may include an application-specific integrated circuit (ASIC), a field-programmable gate array (FPGA), and/or another type of integrated circuit or processing logic. Additionally, or alternatively, processor 220 may include a hardware accelerator integrated circuit or processing logic, such as a graphics processing unit (GPU), a tensor processing unit (TPU), quantum annealing processor, and/or another type of hardware accelerator.

Memory 230 may include any type of dynamic storage device that may store information and/or instructions, for execution by processor 220, and/or any type of non-volatile storage device that may store information for use by processor 220. For example, memory 230 may include a random access memory (RAM) or another type of dynamic storage device, a read-only memory (ROM) device or another type of static storage device, a content addressable memory (CAM), a magnetic and/or optical recording memory device and its corresponding drive (e.g., a hard disk drive, optical drive, etc.), and/or a removable form of memory, such as a flash memory.

Input device 240 may allow an operator to input information into device 200. Input device 240 may include, for example, a keyboard, a mouse, a pen, a microphone, a remote control, an audio capture device, an image and/or video capture device, a touch-screen display, and/or another type of input device. In some embodiments, device 200 may be managed remotely and may not include input device 240. In other words, device 200 may be “headless” and may not include a keyboard, for example.

Output device 250 may output information to an operator of device 200. Output device 250 may include a display, a printer, a speaker, and/or another type of output device. For example, device 200 may include a display, which may include a liquid-crystal display (LCD) for displaying content to the customer. In some embodiments, device 200 may be managed remotely and may not include output device 250. In other words, device 200 may be “headless” and may not include a display, for example.

Communication interface 260 may include a transceiver that enables device 200 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.), or a combination of wireless and wired communications. Communication interface 260 may include a transmitter that converts baseband signals to RF signals and/or a receiver that converts RF signals to baseband signals. Communication interface 260 may be coupled to one or more antennas/antenna arrays for transmitting and receiving RF signals.

Communication interface 260 may include a logical component that includes input and/or output ports, input and/or output systems, and/or other input and output components that facilitate the transmission of data to other devices. For example, communication interface 260 may include a network interface card (e.g., Ethernet card) for wired communications and/or a wireless network interface (e.g., a WiFi) card for wireless communications. Communication interface 260 may also include a universal serial bus (USB) port for communications over a cable, a Bluetooth™ wireless interface, a radio-frequency identification (RFID) interface, a near-field communications (NFC) wireless interface, and/or any other type of interface that converts data from one form to another form.

As will be described in detail below, device 200 may perform certain operations relating to managing interference between a TN and an NTN using the same spectrum. Device 200 may perform these operations in response to processor 220 executing software instructions contained in a computer-readable medium, such as memory 230. A computer-readable medium may be defined as a non-transitory memory device. A memory device may be implemented within a single physical memory device or spread across multiple physical memory devices. The software instructions may be read into memory 230 from another computer-readable medium or from another device. The software instructions contained in memory 230 may cause processor 220 to perform processes described herein. Alternatively, hardwired circuitry may be used in place of, or in combination with, software instructions to implement processes described herein. Thus, implementations described herein are not limited to any specific combination of hardware circuitry and software.

Although FIG. 2 shows exemplary components of device 200, in other implementations, device 200 may include fewer components, different components, additional components, or differently arranged components than depicted in FIG. 2. Additionally, or alternatively, one or more components of device 200 may perform one or more tasks described as being performed by one or more other components of device 200.

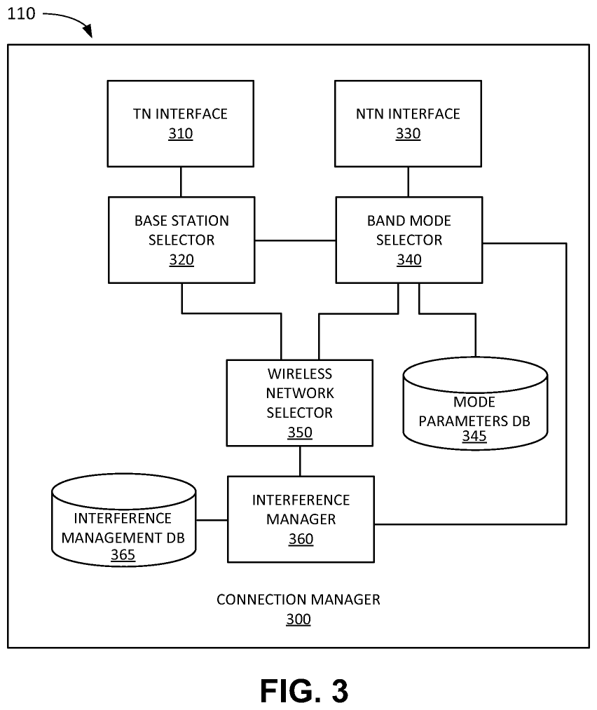

FIG. 3 is a diagram illustrating exemplary components of UE device 110. The components of UE device 110 may be implemented, for example, via processor 220 executing instructions from memory 230. Alternatively, some or all of the components of UE device 110 may be implemented via hard-wired circuitry. As shown in FIG. 3, UE device 110 may include a TN interface 310, a base station selector 320, an NTN interface 330, a band mode selector 340, a mode parameters database (DB) 345, a wireless network selector 350, an interference manager 360, and an interference management DB 365.

TN interface 310 may be configured to communicate with TN base stations 120. TN interface 310 may be configured to operate in one or more 5G NR bands, including a band also used by NTN base stations (e.g., a Ka band, etc.). TN interface 310 may be configured to operate in a full-band mode that uses a whole band, or in a sub-band mode that uses a sub-band of a band. Band mode selector 340 may instruct TN interface 310 to operate in a sub-band mode based on one or more sub-band parameters.

Base station selector 320 may select a particular base station 120. For example, base station selector 320 may scan for a Primary Synchronization Signal (PSS) and may determine a signal strength associated with the PSS. Base station selector 320 may then select base station 120 associated with the strongest PSS as the base station to which to send a registration request.

NTN interface 330 may be configured to communicate with TN base stations 120 via satellite 115. NTN interface 330 may be configured to operate in a 5G NR satellite band (e.g., a Ka band, etc.). NTN interface 330 may be configured to operate in a full-band mode that uses a whole band, or in a sub-band mode that uses a sub-band of a band. Band mode selector 340 may instruct NTN interface 330 to operate in a sub-band mode based on one or more sub-band parameters.

Band mode selector 340 may select a full-band mode or a sub-band mode for communicating with base station 120 based on information received from interference manager 360. For example, if interference manager 360 does not detect a TN base station and does not detect CLI with another UE device 110, band mode selector 340 may select a full-band mode for communicating with an NTN. If interference manager 360 detects a TN base station and/or detects CLI with another UE device 110, band mode selector 340 may select a sub-band mode for communicating with an NTN. Furthermore, band mode selector 340 may select a full-band mode for communicating with a TN, unless band mode selector 340 receives an instruction from a TN base station to operate in sub-band mode.

Band mode selector 340 may select a sub-band filter to use for implementing a sub-band mode, select one or more antenna beams to use, and/or select one or more antenna beams to blacklist from being used for the sub-band mode. TN interface 310 and/or NTN interface 330 may apply the selected sub-band filter, and/or perform beam steering based on the selected and/or blacklisted antenna beams, when communicating with base station 120 and/or satellite 115 in the sub-band mode.

Mode parameters DB 345 may store one or more mode parameters for a sub-band mode. For example, mode parameters DB 345 may store information for one or more sub-bands. For each sub-band, mode parameters DB 345 may store information identifying a sub-band, whether the sub-band is to be used for TN communication or NTN communication, a frequency range for the sub-band, one or more channels for the sub-band, one or more antenna beams for the sub-band, one or more antenna beams that are blacklisted from the sub-band (e.g., not to be used in connection with the sub-band), one or more time slots in a time division multiplexing scheme that are to be used in connection with the sub-band, and/or other types of sub-band mode parameters.

Wireless network selector 350 may select a TN or an NTN based on information obtained by interference manager 360. If wireless network selector 350 selects a TN, wireless network selector 350 may instruct TN interface 310 to send a registration request to a TN base station 120. If wireless network selector 350 selects an NTN, wireless network selector 350 may instruct NTN interface 330 to send a registration request to an NTN base station 120 via satellite 115.

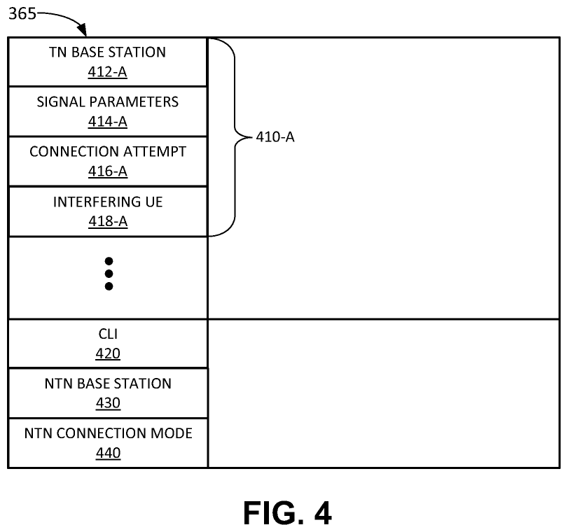

Interference manager 360 may determine whether a TN base station was detected and/or whether CLI with another UE device 110 was detected. For example, interference manager 360 may determine whether a PSS from base station 120 was detected and/or whether an SRS from another UE device 110 was detected. Furthermore, interference manager 360 may determine whether a PSS from an NTN base station was detected from satellite 115. Interference manager 360 may store the determined information in interference management DB 365. Exemplary information that may be stored in interference management DB 365 is described below with reference to FIG. 4.

Although FIG. 3 shows exemplary components of UE device 110, in other implementations, UE device 110 may include fewer components, different components, additional components, or differently arranged components than depicted in FIG. 3. Additionally, or alternatively, one or more components of UE device 110 may perform one or more tasks described as being performed by one or more other components of UE device 110.

FIG. 4 illustrates exemplary components of interference management DB 365 according to an implementation described herein. As shown in FIG. 4, interference management DB 365 may include one or more base station fields 410, a CLI field 420, an NTN base station field 430, and an NTN connection mode field 440.

Each base station field 410 may store information associated with a TN base station 120 for which a PSS was detected. Base station field 410 may include a TN base station field 412, a signal parameters field 414, a connection attempt field 416, and an interfering UE field 418.

TN base station field 412 may store information identifying a TN base station detected by UE device 110. For example, TN base station field 412 may store a base station identifier (ID) associated with the identified TN base station. Signal parameters field 414 may store one or more signal parameters associated with the identified TN base station. For example, signal parameters field 414 may store signal parameters associated with a received PSS from the identified TN base station, such as, for example, a signal strength and/or quality value for the signal strength of the PSS perceived by UE device 110. The signal strength value may include a Reference Signal Received Power (RSRP) power, a Reference Signal Received Quality Value (RSRQ), a Signal to Interference and Noise Ratio (SINR) value, and/or another type of signal strength and/or quality value.

Connection attempt field 416 may store information identifying whether a connection attempt to the TN base station was successful. Interfering UE field 418 may store information identifying whether the UE device 110 has designated itself as an interfering UE device with respect to the identified TN base station.

CLI field 420 may store information identifying whether UE device 110 has detected CLI with respect to another UE device 110. If CLI has been detected, CLI field 420 may store information identifying one or more CLI parameters, such as a signal strength for an SRS received from the other UE device 110, information identifying the other UE device 110, and/or information identifying base station 120 associated with the other UE device 110.

NTN base station field 430 may store information identifying an NTN base station 120, and/or satellite 115 associated with the NTN base station 120, which has been detected by UE device 110. NTN connection mode field 440 may store information identifying whether UE device 110 is to connect to the NTN base station using full-band mode or using sub-band mode. Although FIG. 4 shows exemplary components of interference management DB 365,

in other implementations, interference management DB 365 may store fewer components, different components, additional components, or differently arranged components than depicted in FIG. 4.

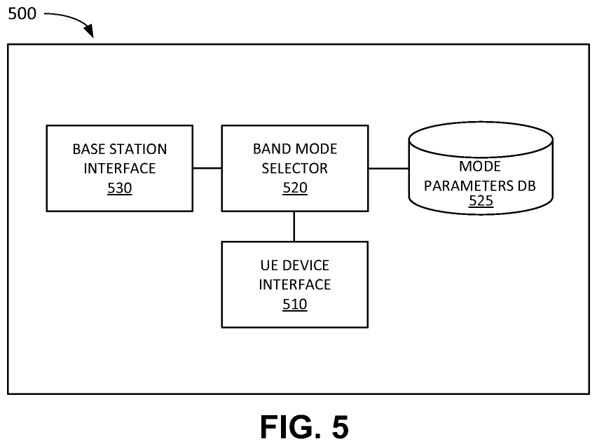

FIG. 5 is a diagram illustrating exemplary components of satellite 115 or base station 120. The components of satellite 115 or base station 120 may be implemented, for example, via processor 220 executing instructions from memory 230. Alternatively, some or all of the components of satellite 115 or base station 120 may be implemented via hard-wired circuitry. As shown in FIG. 5, satellite 115 or base station 120 may include a UE device interface 510, a band mode selector 520, a mode parameters DB 525, and a base station interface 530.

UE device interface 510 may be configured to communicate with UE devices 110. For example, UE device interface 510 may implement a 5G NR air interface between a gNodeB and UE device 110. Band mode selector 520 may select a full-band mode or a sub-band mode for base station 120. If UE device 110 sends a registration request to base station 120 via UE device interface 510 along with a request to operate in a sub-band mode, band mode selector 520 may select to operate in sub-band mode. The registration request from UE device 110 may include information identifying another base station 120 with respect to which UE device 110 may be considered an interfering device. In response, band mode selector 520 may communicate with the other base station 120 to operate in sub-band mode.

Band mode selector 520 may select one or more sub-band mode parameters for base station 120 based on information stored in mode parameters DB 525 and communicate with the other base station 120 using base station interface 530 to establish sub-band mode communication. Base station interface 530 may implement, for example, a 5G Xn interface. The sub-band parameters may include information identifying which sub-band is to be used for TN communication or NTN communication, a frequency range for each sub-band, one or more channels for each sub-band, one or more antenna beams for each sub-band, one or more antenna beams that are blacklisted from each sub-band, one or more time slots in a time division multiplexing scheme that are to be used in connection with each sub-band, and/or other types of sub-band mode parameters.

Band mode selector 520 may select a sub-band filter to use for implementing a sub-band mode, select one or more antenna beams to use, and/or select one or more antenna beams to blacklist from being used for the sub-band mode. UE device interface 510 may apply the selected sub-band filter, and/or perform beam steering based on the selected and/or blacklisted antenna beams, when communicating with UE devices 110 in the sub-band mode.

For example, satellite 115, associated with an NTN base station 120, may use a first sub-band, and a TN base station 120, with which UE device 110 registered with the NTN base station 120 may interfere, may use a second sub-band. Furthermore, UE device 110 may be instructed to use an antenna beam that points skyward and to blacklist an antenna beam that points toward the TN base station 120 with which UE device 110 may interfere, satellite 115 may be instructed to use an antenna beam that points towards the ground, and the TN base station 120 may be instructed to blacklist antenna beams that point skyward or toward the location of the interfering UE device 110.

Although FIG. 5 shows exemplary components of satellite 115 or base station 120, in other implementations, satellite 115 or base station 120 may include fewer components, different components, additional components, or differently arranged components than depicted in FIG. 5. Additionally, or alternatively, one or more components of satellite 115 or base station 120 may perform one or more tasks described as being performed by one or more other components of satellite 115 or base station 120.

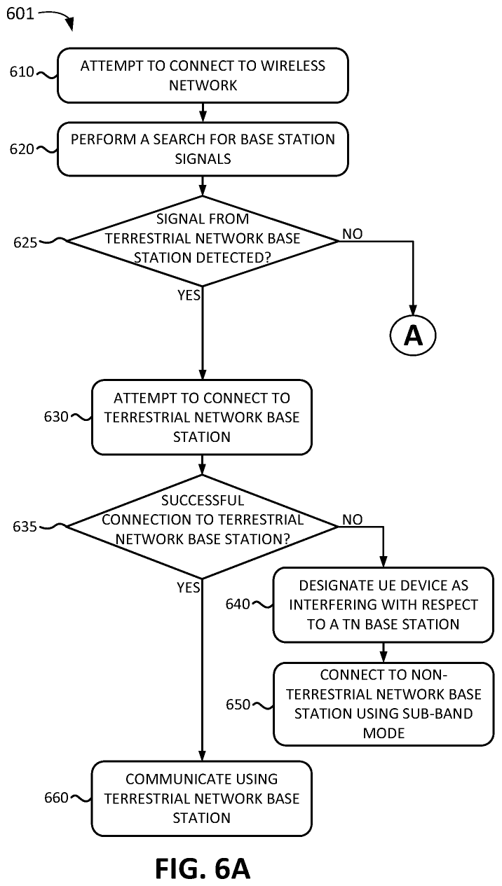

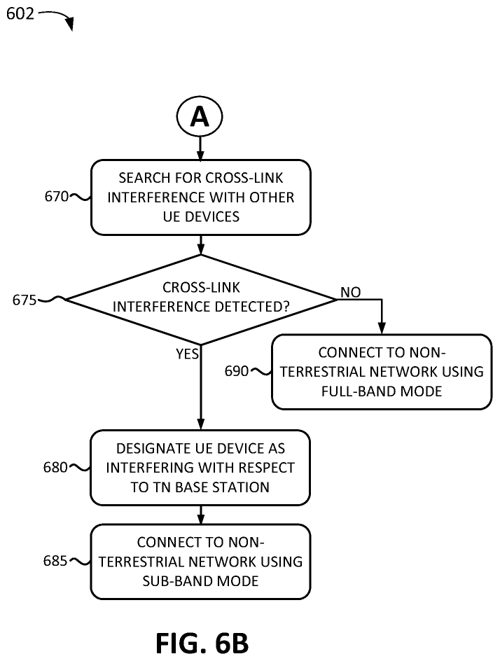

FIGS. 6A and 6B illustrate flowcharts of processes 601 and 602 for selecting a communication mode according to an implementation described herein. In some implementations, the processes of FIGS. 6A and 6B may be performed by UE device 110. In other implementations, some or all of the processes of FIGS. 6A and 6B may be performed by another device or a group of devices separate from UE device 110.

Process 601 may include attempting to connect to a wireless network (block 610) and performing a search for base station signals (block 620). For example, UE device 110 may be communicating with a first base station 120 and may exit the coverage area of the first base station 120, enter a new area, and perform a search for base stations 120 in the new area. UE device 110 may search for a PSS in the new area. Furthermore, UE device 110 may also identify a PSS from satellite 115 associated with an NTN.

A determination may be made as to whether a signal from a TN base station is detected (block 625). For example, UE device 110 may determine whether at least one PSS has been detected. If a signal from a TN base station is detected (block 625—YES), UE device 110 may attempt to connect to the TN base station (block 630). For example, UE device 110 may obtain a system information block (SIB) from the TN base station 120 and then send a registration request to the identified TN base station associated with the detected PSS.

A determination may be made as to whether a successful connection to the TN base station was established (block 635). For example, UE device 110 may determine whether the identified TN base station 120 responded with a registration acceptance message and whether a registration procedure was successfully completed. If the connection to the TN base station was successfully established (block 635—YES), communication may proceed using the TN base station (block 660). For example, UE device 110 may communicate with application server 170 in PDN 160 via core network 150 and may terminate any attempts to connect to an NTN base station 120 via satellite 115.

If the connection to the TN base station was not successfully established (block 635—NO), UE device 110 may designate itself as an interfering UE device with respect to a TN base station (block 640) and connect to an NTN base station using a sub-band mode (block 650). For example, UE device 110 may designate itself as an interfering UE device with respect to the TN base station in interference management DB 365 based on detecting a PSS for the TN base station with a signal strength greater than an interference threshold, and may send a request to satellite 115 to register with the NTN base station 120 associated with satellite 115 using sub-band mode. The registration request may include information identifying the TN base station with respect to which UE device 110 is designated as an interfering UE device.

Returning to block 625, if a signal from a TN base station was not detected (block 625-NO), processing may continue to process 602 of FIG. 6B. As shown in FIG. 6B, process 602 may include searching for CLI with other UE devices (block 670). In some implementations, CLI may be detected by a UE device 110 that may be a victim of interference. For example, a TN base station 120 may configure UE devices 110 registered with the TN base station 120 to transmit an SRS and an NTN base station 120 may configure devices attempting to register with the NTN base station 120 to receive the SRS from other UE devices 110, including the time and frequency information and SRS settings associated with the SRS.

In other implementations, CLI may be detected by UE device 110 that may be causing interference. For example, an NTN base station 120 may configure the NTN to transmit the SRS, including the time and frequency information and SRS settings associated with the SRS, and the NTN UE devices 110 may pre-compensate the timing and frequency for the SRS based on a Global Navigation Satellite System (GNSS) so the timing and frequency information is aligned with the TN. The TN base station 120 may configure UE devices 110 registered with the TN base station 120 to receive and measure the SRS and/or a Received Signal Strength Indicator (RSSI) value.

As another example, the NTN base station 120 may configure the NTN to a Channel State Information Reference Signal (CSI-RS), including the time and frequency information and CSI-RS settings associated with the CSI-RS. The NTN UE devices 110 may pre-compensate the timing and frequency for the CSI-RS based on the GNSS information so the CSI-RS timing and frequency are aligned with the TN. The TN base station 120 may then configure UE devices 110 registered with the TN base station 120 to receive and measure Non-Zero Power (NZP) CSI-RS.

If CLI is detected (block 675—YES), UE device 110 may designate itself as an interfering UE device with respect to a TN base station (block 680) and connect to an NTN base station using a sub-band mode (block 685). For example, UE device 110 may designate itself as an interfering UE device with respect to the TN base station in interference management DB 365 based on detecting CLI for another UE device 110 registered with a TN base station 120, and may send a request to satellite 115 to register with the NTN base station 120 associated with satellite 115 using sub-band mode. The registration request may include information identifying the TN base station, associated with the other UE device 110 for which CLI was detected, with respect to which UE device 110 is designated as an interfering UE device.

If CLI is not detected (block 675-NO), UE device 110 may connect to an NTN base station using a full-band mode (block 690). For example, UE device 110 may not be causing any interference with respect to TN base stations 120 or other UE devices 110 and may therefore use the full band to communicate with the NTN. For example, UE device 110 may send a request to satellite 115 to register with the NTN base station 120 associated with satellite 115 using full-band mode.

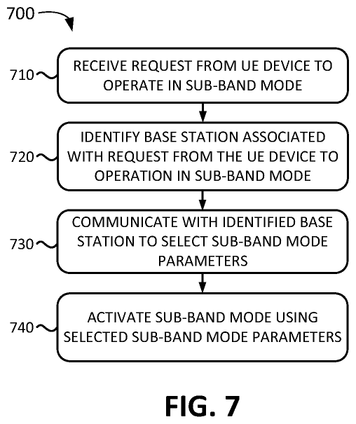

FIG. 7 illustrates a flowchart of a process 700 for establishing a sub-band mode according to an implementation described herein. In some implementations, the process of FIG. 7 may be performed by satellite 115 and/or base station 120. In other implementations, some or all of the process of FIG. 7 may be performed by another device or a group of devices separate from satellite 115 and/or base station 120.

Process 700 may include receiving a request from a UE device to operate in a sub-band mode (block 710) and identifying a base station associated with the request from the UE device to operate in the sub-band mode (block 720). For example, an NTN base station 120 may receive a registration request from UE device 110 to register with the NTN via satellite 115 using sub-band mode. The registration request from UE device 110 may include information identifying another base station 120 with respect to which UE device 110 may be considered an interfering device.

Process 700 may further include communicating with the identified base station to select sub-band mode parameters (block 730) and activating sub-band mode using the selected sub-band mode parameters (block 740).

For example, NTN base station 120 may select one or more sub-band mode parameters communicate with the other base station 120 to establish sub-band mode communication. The sub-band parameters may include information identifying which sub-band is to be used for TN communication or NTN communication, a frequency range for each sub-band, one or more channels for each sub-band, one or more antenna beams for each sub-band, one or more antenna beams that are blacklisted from each sub-band, one or more time slots in a time division multiplexing scheme that are to be used in connection with each sub-band, and/or other types of sub-band mode parameters.

For example, satellite 115, associated with an NTN base station 120, may use a first sub-band, and a TN base station 120, with which UE device 110 registered with the NTN base station 120 may interfere, may use a second sub-band. NTN base station 20 may also instruct UE device 110 to use an antenna beam that points skyward and to blacklist an antenna beam that points toward the TN base station 120 with which UE device 110 may interfere, instruct satellite 115 to use an antenna beam that points towards the ground, and complete registration procedure with UE device 110. UE device 110 may then communicate with the NTN using sub-band mode. For example, UE device 110 may communicate with application server 170 in PDN 160 via core network 150, RAN 130, and satellite 115.

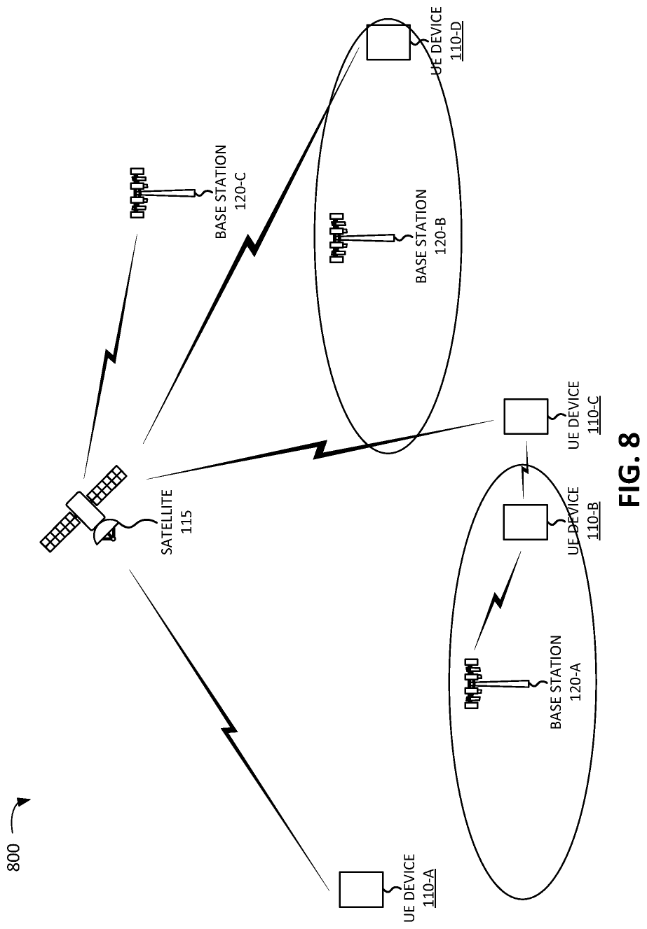

FIG. 8 illustrates an exemplary system 800 that includes a TN and an NTN according to an implementation described herein. As shown in FIG. 8, system 800 may include satellite 115, base station 120-A, base station 120-B, base station 10-C, UE device 110-A, UE device 110-B, UE device 110-C, and UE device 110-D. Satellite 115 may function as a repeated for base station 110-C. Thus, satellite 115 and base station 110-C may be part of an NTN. Base station 120-A and base station 120-B may be part of a TN. UE device 110-A may be outside the coverage area of base stations 110-A and 110-B. UE device 110-B may be in the coverage area of base station 120-A. UE device 110-C may be outside the coverage area of base stations 110-A and 110-B and may cause CLI with respect to UE device 110-B. UE device 110-D may be on the edge of the coverage area of base station 120-B.

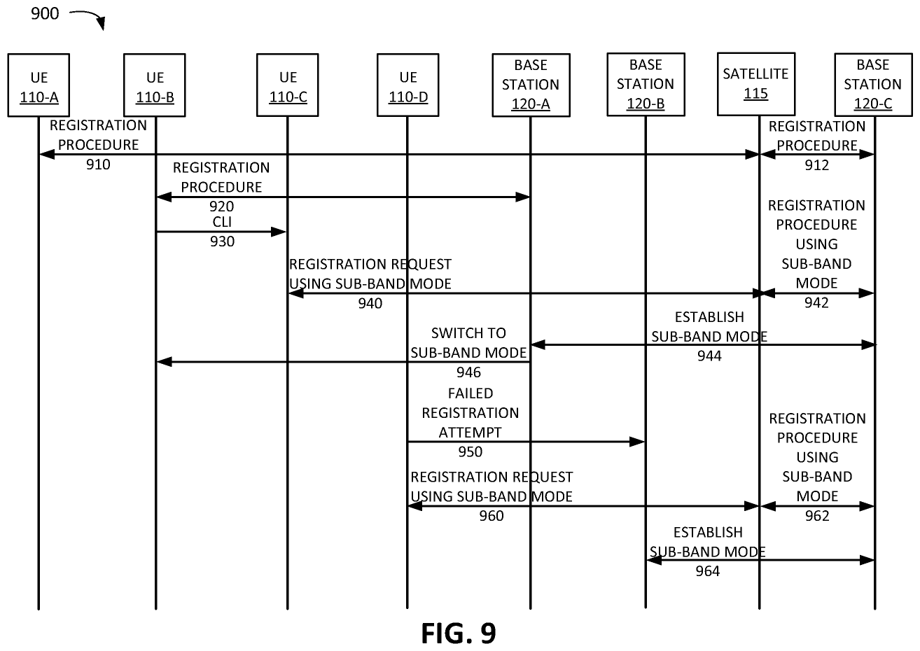

FIG. 9 illustrates an exemplary signal flow 900 associated with system 800 of FIG. 8 according to an implementation described herein. As shown in FIG. 9, signal flow 900 may include UE device 110-A performing a registration procedure with base station 120-C via satellite 115 (signals 910 and 912). For example, UE device 110-C may determine that no PSS from a base station has been detected and no CLI with another UE device 110 has been detected. In response, UE device 110-A may designate itself as a non-interfering UE device and may request communication with satellite 115 using a full-band mode. After registering with base station 120-C, UE device 110-A may communicate with base station 120-C via satellite 115 using the full Ka band assigned to the NTN.

UE device 110-B may detect the PSS from base station 120-A, send a registration request to base station 120-A, and perform a registration procedure to register with base station (signal 920). At a later time, UE device 110-C may select to connect to a wireless network and may detect a PSS from satellite 115. UE device 110-C may attempt to detect a PSS from a TN base station and may detect no TN base stations. UE device 110-C may then detect an SRS from UE device 110-B, identify CLI with UE device 110-B based on the detected SRS, and designate itself an interfering UE device based on the identified CLI. In response, UE device 110-C may request communication with base station 120-C via satellite 115 using a sub-band mode (signals 940 and 942). The request may include information identifying the CLI, UE device 110-B associated with the CLI, and base station 120-A with which UE device 110-B is registered.

UE device 110-C may thus register with base station 120-C via satellite 115. In response, base station 120-C may switch to sub-band mode and may coordinate with base station 120-A to establish sub-band mode (signal 944). Base station 120-A may select a set of sub-band parameters, such as a frequency range and/or channels, antenna beams, and/or time slots for a sub-band and may instruct UE device 110-B (and/or other UE devices 110 registered with base station 120-A) to switch to sub-band mode using the selected sub-band parameters (signal 946).

UE device 110-D may select to connect to a wireless network and may detect a PSS from satellite 115. UE device 110-D may attempt to detect a PSS from a TN base station and may detect the PSS from base station 120-B. UE device 110-D may send a registration request to base station 120-B and determine that the registration attempt with base station 120-B was not successful (signal 950). In response, UE device 110-D may designate itself as an interfering UE device and may send a registration request to base station 120-C via satellite 115 using a sub-band mode (signals 960 and 962). The request may include information identifying base station 120-B as a base station that may experience interference from UE device 110-D.

UE device 110-D may thus register with base station 120-C via satellite 115. In response, base station 120-C may switch to sub-band mode and may coordinate with base station 120-B to establish sub-band mode (signal 964). Base station 120-B may select a set of sub-band parameters, such as a frequency range and/or channels, antenna beams, and/or time slots for a sub-band and may any UE devices 110 registered with base station 120-B to switch to sub-band mode using the selected sub-band parameters (not shown in FIG. 9).

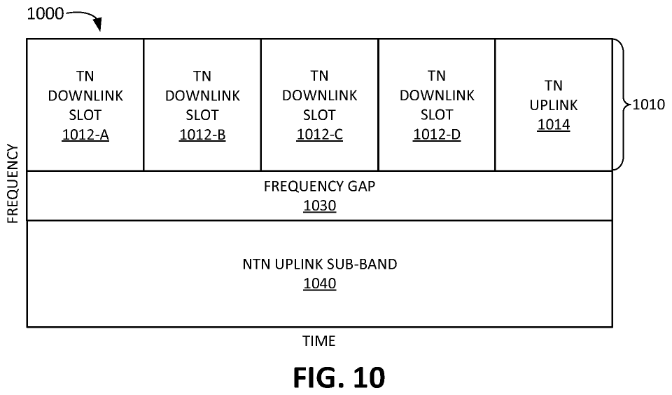

FIG. 10 illustrates an exemplary band 1000 with sub-bands according to an implementation described herein. As shown in FIG. 10, band 1000 may include a sub-band 1010 for a TN, a frequency gap 1030, and a sub-band 1040 for an NTN. Sub-band 1010 may be used by TN base stations 120 and may include a set of time slots that include a first TN downlink time slot 1012-A, a TN downlink time slot 1012-B, a third TN downlink time slot 1012-C, a fourth TN downlink time slot 1012-D, and a TN uplink time slot 1014. In other implementations, sub-band 1010 may include full duplex time slots or may not be divided into uplink versus downlink time slots. Frequency gap 1030 may ensure that sub-band 1010 and sub-band 1040 do not cause interference with each other. NTN uplink sub-band 1040 may be used for uplink communication from UE device 110 to satellite 115.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

For example, while a series of blocks have been described with respect to FIGS. 6A, 6B, and 7, and a series of signals have been described with respect to FIG. 9, the order of the blocks and/or signals may be modified in other implementations. Further, non-dependent blocks and/or signals may be performed in parallel.

It will be apparent that systems and/or methods, as described above, may be implemented in many different forms of software, firmware, and hardware in the implementations illustrated in the figures. The actual software code or specialized control hardware used to implement these systems and methods is not limiting of the embodiments. Thus, the operation and behavior of the systems and methods were described without reference to the specific software code-it being understood that software and control hardware can be designed to implement the systems and methods based on the description herein.

Further, certain portions, described above, may be implemented as a component that performs one or more functions. A component, as used herein, may include hardware, such as a processor, an ASIC, or a FPGA, or a combination of hardware and software (e.g., a processor executing software).

It should be emphasized that the terms “comprises”/“comprising” when used in this specification are taken to specify the presence of stated features, integers, steps or components but does not preclude the presence or addition of one or more other features, integers, steps, components or groups thereof.

The term “logic,” as used herein, may refer to a combination of one or more processors configured to execute instructions stored in one or more memory devices, may refer to hardwired circuitry, and/or may refer to a combination thereof. Furthermore, a logic may be included in a single device or may be distributed across multiple, and possibly remote, devices.

For the purposes of describing and defining the present invention, it is additionally noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

To the extent the aforementioned embodiments collect, store, or employ personal information of individuals, it should be understood that such information shall be collected, stored, and used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction used in the present application should be construed as critical or essential to the embodiments unless explicitly described as such. Also, as used herein, the article “a” is intended to include one or more items. Further, the phrase “based on” is intended to mean “based, at least in part, on” unless explicitly stated otherwise.

What is claimed is:

1. A method comprising:
attempting, by a user equipment (UE) device, to connect to a wireless network;
detecting, by the UE device, a base station signal from a terrestrial network (TN) base station;
determining, by the UE device, that a connection attempt to the TN base station was not successful;
designating, by the UE device, the UE device as an interfering UE device, based on detecting the base station signal from the TN base station and determining that the connection attempt to the TN base station was not successful; and
connecting, by the UE device, to a non-terrestrial (NTN) base station using a sub-band mode, in response to designating the UE device as an interfering UE device.

2. The method of claim 1, wherein the UE device detecting the base station signal from the TN base station includes:
performing a cell search to identify TN base stations; and
detecting a primary synchronization signal transmitted by the TN base station.

3. The method of claim 1, wherein connecting to the NTN base station using the sub-band mode includes:
connecting the UE device to a satellite associated with the NTN base station.

4. The method of claim 1, wherein connecting the UE device to the NTN base station using the sub-band mode includes:
applying a sub-band filter to signals sent from the UE device to the NTN base station or to signals received by the UE device from the NTN base station.

5. The method of claim 1, wherein connecting the UE device to the NTN base station using the sub-band mode includes:
selecting, by the UE device, an antenna beam that does not interfere with the TN base station.

6. The method of claim 1, further comprising:
making another attempt, by the UE device, to connect to a wireless network;
determining, by the UE device, that a base station signal from the TN base station was not detected;
determining, by the UE device, that cross-link interference with another UE device was not detected;
designating the UE device as a non-interfering UE device, in response to determining that the base station signal from the TN station was not detected and that the cross-link interference with the other UE device was not detected; and
connecting the UE device to the NTN base station using a full-band mode, in response to designating the UE device as a non-interfering UE device.

7. The method of claim 1, further comprising:
making another attempt, by the UE device, to connect to a wireless network;
determining, by the UE device, that a base station signal from a TN base station was not detected;
detecting, by the UE device, cross-link interference with another UE device;
designating, by the UE device, the UE device as an interfering UE device based on detecting the cross-link interference with the other UE device; and
connecting, by the UE device, to the NTN base station using the sub-band mode, in response to designating the UE device as an interfering UE device.

8. The method of claim 7, wherein detecting, by the UE device, the cross-link interference with the other UE device includes:
detecting a Sounding Reference Signal (SRS) from the other UE device.

9. The method of claim 1, further comprising:
making, by the UE device, another attempt to connect to a wireless network;
determining, by the UE device, that the base station signal from the TN base station was detected;
making, by the UE device, another connection attempt to the TN base station;
determining, by the UE device, that the other connection attempt to the TN base station was successful; and
terminating, by the UE device, an attempt to connect to the NTN base station, in response to determining that the other connection attempt to the TN base station was successful.

10. A user equipment (UE) device comprising:
a processor configured to:
attempt to connect to a wireless network;
detect a base station signal from a terrestrial network (TN) base station;
determine that a connection attempt to the TN base station was not successful;
designate the UE device as an interfering UE device, based on detecting the base station signal from the TN base station and determining that the connection attempt to the TN base station was not successful; and
connect to a non-terrestrial (NTN) wireless network using a sub-band mode, in response to designating the UE device as an interfering UE device.

11. The UE device of claim 10, wherein, when detecting the base station signal from the TN base station, the processor is further configured to:
perform a cell search to identify TN base stations; and
detect a primary synchronization signal transmitted by the TN base station.

12. The UE device of claim 10, wherein, when connecting to the NTN base station using the sub-band mode, the processor is further configured to:
connect the UE device to a satellite associated with the NTN base station.

13. The UE device of claim 10, wherein, when connecting to the NTN base station using the sub-band mode, the processor is further configured to:
apply a sub-band filter to signals sent to the NTN base station or to signals received from the NTN base station.

14. The UE device of claim 10, wherein, when connecting to the NTN base station using the sub-band mode, the processor is further configured to:
select an antenna beam that does not interfere with the TN base station.

15. The UE device of claim 10, wherein the processor is further configured to:
make another attempt to connect to a wireless network;
determine that a base station signal from the TN base station was not detected;
determine that cross-link interference with another UE device was not detected;
designate the UE device as a non-interfering UE device, in response to determining that the base station signal from the TN station was not detected and that the cross-link interference with the other UE device was not detected; and
connect to the NTN base station using a full-band mode, in response to designating the UE device as a non-interfering UE device.

16. The UE device of claim 10, wherein the processor is further configured to:
make another attempt to connect to a wireless network;
determine that a base station signal from a TN base station was not detected;
detect cross-link interference with another UE device;
designate the UE device as an interfering UE device based on detecting the cross-link interference with the other UE device; and
connect to the NTN base station using the sub-band mode, in response to designating the UE device as an interfering UE device.

17. The UE device of claim 16, wherein, when detecting the cross-link interference with the other UE device, the processor is further configured to:
detect a Sounding Reference Signal (SRS) from the other UE device.

18. The UE device of claim 10, wherein the processor is further configured to:
make another attempt to connect to a wireless network;
determine that the base station signal from the TN base station was detected;
make another connection attempt to the TN base station;
determine that the other connection attempt to the TN base station was successful; and
terminate an attempt to connect to the NTN base station, in response to determining that the other connection attempt to the TN base station was successful.

19. A non-transitory computer-readable memory device storing instructions executable by a processor, the non-transitory computer-readable memory device comprising:
one or more instructions to attempt to connect to a wireless network;
one or more instructions to detect a base station signal from a terrestrial network (TN) base station;
one or more instructions to determine that a connection attempt to the TN base station was not successful;
one or more instructions to designate the UE device as an interfering UE device, based on detecting the base station signal from the TN base station and determining that the connection attempt to the TN base station was not successful; and
one or more instructions to connect to a non-terrestrial (NTN) wireless network using a sub-band mode, in response to designating the UE device as an interfering UE device.

20. The non-transitory computer-readable memory device of claim 19, further comprising:
one or more instructions to make another attempt to connect to a wireless network;
one or more instructions to determine that a base station signal from a TN base station was not detected;
one or more instructions to detect cross-link interference with another UE device;
one or more instructions to designate the UE device as an interfering UE device based on detecting the cross-link interference with the other UE device; and
one or more instructions to connect to the NTN base station using the sub-band mode, in response to designating the UE device as an interfering UE device.
